(19) United States
(12) Patent Application Publication
(10) Pub. No.: US 2002/0178187 A1
(43) Pub. Date: Nov. 28, 2002

(54) Electronically signed HTML forms

(76) Inventors: Brett D. Rasmussen, Idaho Falls, ID (US); Wayne E. Austad, Idaho Falls, ID (US); Catherine Herring Macheret, Arlington, VA (US)

Correspondence Address: Alan D. Kirsch, INEEL, P.O. BOX 1625, Idaho Falls, ID, 83415, US

(21) Appl. No.: 10/028,886

(22) Filed: Dec. 19, 2001

Related U.S. Application Data
(60) Provisional application No. 60/257,123, filed on Dec. 20, 2000.

(51) Int. Cl. G06F 15/00

(52) U.S. Cl. 707/513

(57) ABSTRACT

A hypertext markup language form is electronically signed by loading it into a browser application and generating an electronic signature for information in the form from within the browser application.

### RELATED APPLICATION

The present application claims the benefit of U.S. Provisional Patent Application Ser. No. 60/257,123, filed Dec. 20, 2000, entitled “Digitally Signed HTML Forms (DSHF) Design Outline,” which is hereby incorporated by reference.

### CONTRACTUAL ORIGIN OF THE INVENTION

This invention was made with United States Government support under contract number DE-AC07-99ID13727, awarded by the United States Department of energy. The United States Government has certain rights in the invention.

### FIELD OF THE INVENTION

This invention relates generally to Hypertext Markup Language (HTML) forms and more specifically an electronic signature system (ESS) for HTML forms.

### BACKGROUND

The evolution of the World Wide Web and the Internet has transformed the way that information can be shared. As “web” technology has evolved, basic form processing capabilities have been added to the Hypertext Markup Language (HTML) protocol. With HTML form technology, an end user may now interactively enter data into web based forms and have the data uploaded to server computers for real time processing.

With the development of HTML form processing technology, new methods for conducting business transactions have been created. The term “e-commerce” has been coined to describe the transactions that occur between on-line businesses and potential Internet customers. E-commerce transactions include not only customer to business transactions, but also business to business transactions. HTML forms have provided an extremely simple and convenient way for users to conduct business and to make purchases by computer. However, the use of HTML forms introduces some uncertainty over the security of the data in the form and the identity of the user submitting the form. For example, as forms requiring signatures are converted from paper to electronic format as an HTML form, they must still be printed and signed. Forms which can be submitted on-line are submitted without signatures. Although electronic mail related methods exist for electronically signing text to establish identity and to certify that the contents of signed information remains unchanged, no convenient methods of electronically signing HTML forms exist. HTML forms used in e-commerce are often stored with a user identification or name to indicate approval of the data in the form, but this does not provide verification of the signer's identification and the signed data.

### SUMMARY

An HTML form is electronically signed by loading it into a browser application and generating an electronic signature for the form and its field contents from within the browser application. In one exemplary embodiment, the HTML form is displayed in a frame in the browser and control buttons for generating or verifying the electronic signature are displayed in another frame. Data entered into fields in the HTML form is merged with the blank form template and an electronic signature is generated for the merged form within the browser environment and attached to the merged form. The signed merged form can then be transferred as desired, such as across the Internet. The electronic signature for the signed merged form can be verified to confirm the authenticity of the signature and that the contents have not been altered.

### BRIEF DESCRIPTION OF THE DRAWING

Illustrative and presently preferred embodiments of the invention are shown in the accompanying drawing, in which:

FIG. 1 is a screen shot of a World Wide Web browser showing a Display frame with an HTML form to be edited and signed, and a Control frame with control buttons allowing the completed HTML form to be electronically signed;

FIG. 2 is a screen shot of a World Wide Web browser showing a Display frame with an HTML form already filled out and signed, and a Control frame with control buttons allowing the electronic signature on the HTML form to be verified;

FIG. 3 is an overview flow chart illustrating an exemplary process of electronically signing an HTML form;

FIG. 4 is a flow chart illustrating an exemplary process of downloading an empty HTML template;

FIG. 5 is a flow chart illustrating an exemplary process of storing an HTML template with data in the form fields;

FIG. 6 is a flow chart illustrating an exemplary process of merging an HTML template with the data in its form fields;

FIG. 7 is a flow chart illustrating an exemplary process of reloading a merged HTML template;

FIG. 8 is a flow chart illustrating details of an exemplary process of electronically signing an HTML form;

FIG. 9 is a flow chart illustrating an exemplary process of uploading a signed HTML form;

FIG. 10 is a flow chart illustrating an exemplary process of the original application's server side signature response;

FIG. 11 is a flow chart illustrating an exemplary process of verifying the signature of an electronically signed HTML form;

FIG. 12 is a flow chart illustrating an exemplary process of downloading a signed HTML form prior to verification; and

FIG. 13 is a flow chart illustrating details of an exemplary process of verifying the signature of an electronically signed HTML form.

### DESCRIPTION

The drawing and description, in general, disclose a system for applying electronic signatures to hypertext markup language (HTML) forms within a World Wide Web (WWW) browser application or similar application. HTML forms are commonly used in electronic commerce (e-commerce) to allow users to submit information electronically over the Internet using a computer. An HTML form is a web page or template containing blank fields into which data can be entered. Typically, as an HTML form is filled out and submitted or uploaded, only the data is transmitted, not the form. In contrast, the system for applying electronic signatures disclosed herein merges the data with the template (or empty) HTML form and attaches a digital signature to the merged form, creating a portable signed document which can be verified in any browser adapted to the electronic signature system. The electronic signature is generated and attached from within the browser, without requiring the end user to save the HTML form and manipulate it outside the browser. The electronically signed form can also be verified within the browser to certify the authenticity of the signature and confirm that the contents of the form have not been altered.

The merging and subsequent signing of data entered into fields and the HTML form presentation is done in a manner that does not interfere with posting of the data fields (“name/value pairs” in web developer vernacular) to the server application. Hence, the electronic signature system does not interfere with existing data interactions.

The system for electronically signing HTML forms uses existing standards-based Public Key Infrastructure (PKI) techniques and tools for generating and verifying the form's digital signature. Thus, existing PKI infrastructures (available from VeriSign, Inc. of Mountain View, Calif., or the Entrust company of Santa Clara, Calif., etc.) can be used to support the system. PKI digital signatures are the result of encrypting a one-way hash of the data being signed (plus date-time) with the private key of the signer. The hash ensures that the data has not been changed, and encrypting the hash with a private key to produce a digital signature binds the user's identity to that signature and prevents tampering with the hash. Alternatively, any other suitable type of electronic signature technology can be used.

The system for electronically signing HTML forms also allows the use of existing HTML forms without the need for extensive modifications of the forms, thus enabling the security of electronic signatures to be immediately applied to the vast number of existing HTML forms. A web page developer can add electronic signing capability to the HTML form by requesting the system's “wrapper” URL and providing the HTML form URL as the system's URL query string argument.

An exemplary embodiment of the system to electronically sign HTML forms will be described as it may be applied by a plugin and the system's “wrapper” URL for a browser application. It is important to note, however, that the system for electronically signing HTML forms is not limited to use by a plugin for a browser application, but may be adapted for use by any type of software which processes HTML forms, using any suitable manner of adding functionality to the HTML processing software. For example, the system may be embodied as an Active X control for the Internet Explorer browser available from the Microsoft Corporation of Redmond, Wash. The system may alternatively be hard-coded into a web browser such as the Netscape or Internet Explorer browsers. Accordingly, the term “browser” as defined herein refers to any software which displays HTML forms and which allows the entry of data into fields in an HTML form.

The electronic signature system (ESS) in this exemplary embodiment includes a “plugin” module installed on a Netscape client browser, available from Netscape Communications Corporation of Mountain View, Calif., and Common Gateway Interface (CGI) code that is installed on the web server. The plugin code is implemented in C/C++ and the CGI code is implemented in Perl, although they may alternatively be programmed in any suitable language.

The exemplary embodiment of the electronic signature system described herein is made up of six elements, the browser plugin, PKI signature certificates, CGI web server scripts (also referred to as the ESS Server Side Module), a web browser, a web server, and any static or dynamic HTML form that is to be viewed, edited, and signed. The web browser and web server of the exemplary embodiment are conventional unmodified applications that are widely available. The PKI signature certificates are also conventional and are widely available.

The HTML form can be any conventional HTML web page having data fields, with only a few minor additions. The electronic signature system is designed so that the minimum number of alterations to HTML forms is needed.

The control interface needed for storing, signing and verifying the HTML form is provided by the system's “wrapper” URL, the ESS server side module. An exemplary URL request to execute the ESS “wrapper” URL for an HTML form is as follows: http://www.mysite.net/cgi-bin/ess.pl?display_URL=myhtmlform_URL&response_URL=myresponseURL. The ESS “wrapper” URL is the link between the original application in which the HTML form is selected and the storing, signing and verifying functions provided by the ESS plugin and server side scripts.

An HTML form to be signed needs three extra elements to be signed by the exemplary electronic signature system disclosed herein. First, a hidden input field called “ess_session_id” is included in the form using HTML source such as the following: <INPUT TYPE=hidden NAME=“ess_session_id” VALUE=“0”>. This field is a unique identifier for a particular form filling and signing session. Second, the form includes a JavaScript function called “displaySubmit” that sets the value of the “ess_session_id” field and submits the form. Exemplary HTML source for this function is as follows:

<script language=“JavaScript1.1”>

function displaySubmit(signSessionId_value){document.forms[0].ess_session_id.value=signSessionId_value; document.forms[0].submit( );}

</script>

The displaySubmit function in the HTML form is called by a control button in a control frame, to be described below. Third, the form submit action attribute in the form calls a CGI script on the web server that utilizes the system's field merging application programmer's interface (API) to merge the data with the form when the form is posted.

The browser plugin generates an electronic signature for an HTML form using, for example, existing digital certificates, and attaches the electronic signature to the HTML form, as will be described in more detail below. The browser plugin also performs other management tasks such as loading the HTML form, etc., as will be described below.

The system's field merging API server code accepts an empty HTML form and data for fields in the HTML form and merge the data into the form, creating a portable filled out HTML form, as will be described in more detail below.

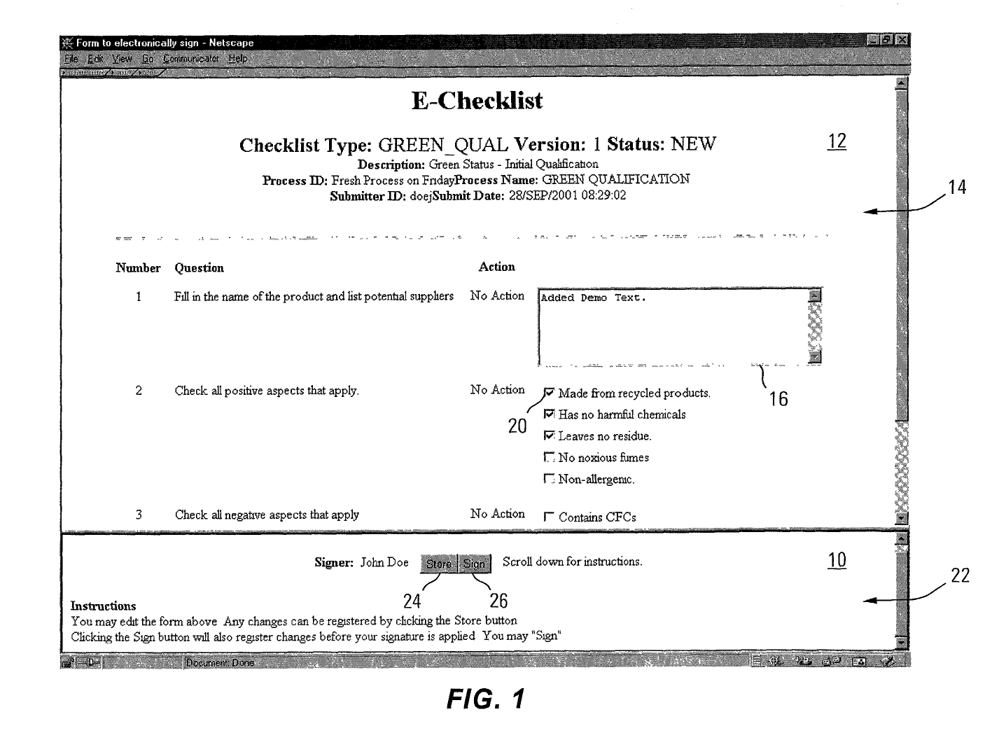

Referring now to FIG. 1, the user interface, rendered by the ESS server side module, for an exemplary embodiment of the electronic signature system consists of two HTML “frames” 10 and 12, although the user interface may alternatively be designed in any suitable fashion. The “control” frame 10 (i.e. the bottom frame) contains user interface controls for manipulating the web page that is displayed in the “display” frame 12. The display frame 12 (i.e. the top frame) contains the HTML form 14 that is to be signed by the user. A typical HTML form 14 contains at least one field (e.g., 16 and 20) for data entry. Sample HTML source code for the page generated by the call to the ESS server side module, which contains the two frames, is as follows:

<html><head><title>Electronic Signature System</title></head>

<frameset rows=“85,15”>

<frame name=display

src=“http://www.mysite.net/˜ess_app/blank_page.htm”>

<frame name=control src=@http://www.mysite.net/cgi-bin/ess.pl/process?ess_session_id=20011126 181744 001&action=start”>

</frameset>

</html>

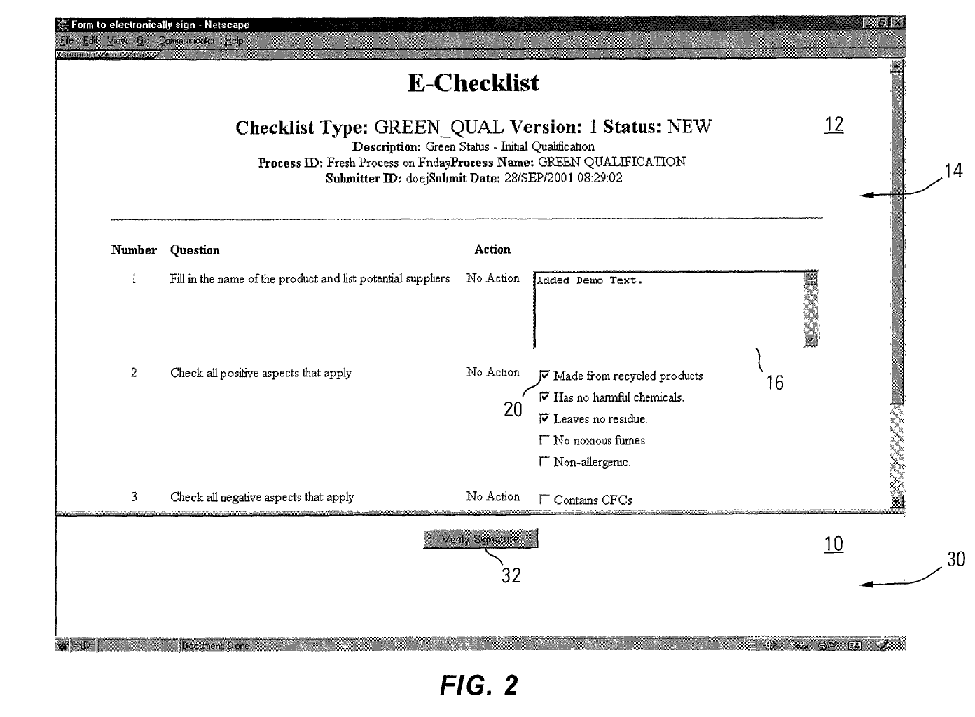

The display frame 12 contains the web page 20011126_{—}181744_{—}001_display.htm, which in the case of FIG. 1 contains an HTML form with data in several of the form fields. The control frame 10 contains the system's dynamically created web page, which in the case of FIG. 1 contains a page 22 having user interface controls such as a “Store” button 24, and a “Sign” button 26. Sample HTML source code for the control frame page 22 of FIG. 1 can be seen at the end of this description. In the case of FIG. 2, the control frame 10 contains a web page 30 having a “Verify” button 32 (FIG. 2). Sample HTML source code for the control frame page 30 of FIG. 2 can also be seen at the end of this description.

These buttons perform the following functions. When the Store button 24 is pressed, the values entered in the form fields (e.g., 16 and 20) are merged with the HTML source for the form 14, and the form 14 is prepared for signing. The user entered form field values are physically embedded into the original empty HTML form page. (The empty form is often referred to as the “template”.) The Store button 24 also causes the control frame form 22 to be submitted. The submission of the control form causes the control frame 10 to be reloaded with an updated configuration of the control form 22, as will be described hereinafter. The Sign button 26 is used to create and attach a digital signature to an HTML form. The Verify button 32 is used to verify the digital signature of a previously signed form.

The display frame 12 is normally used to present a page that contains an HTML <FORM> object. In a typical HTML form where an end user enters data into fields, there would be a “Submit” button. The submit action associated with the button is typically a Web Server script that processes the data entered by the user.

When using the electronic signature system however, the submit action is instigated from the control form, not the display form, by the Store or Sign buttons 24 and 26 on the control form 22. Thus there is no need for a Submit button in the display frame 12. In addition to the Store or Sign buttons 24 and 26 causing the display frame form 14 to be submitted, they also cause the control form 22 to be submitted. The combination of web server submit scripts and plugin actions produces all the functionality needed for electronically signing HTML forms.

The electronic signature system is invoked by requesting the electronic signature server side CGI script and passing two query arguments. The first is the display page Uniform Resource Locator (URL) for the template form to be signed and the “Your Response” URL to be called when the signing process is complete.

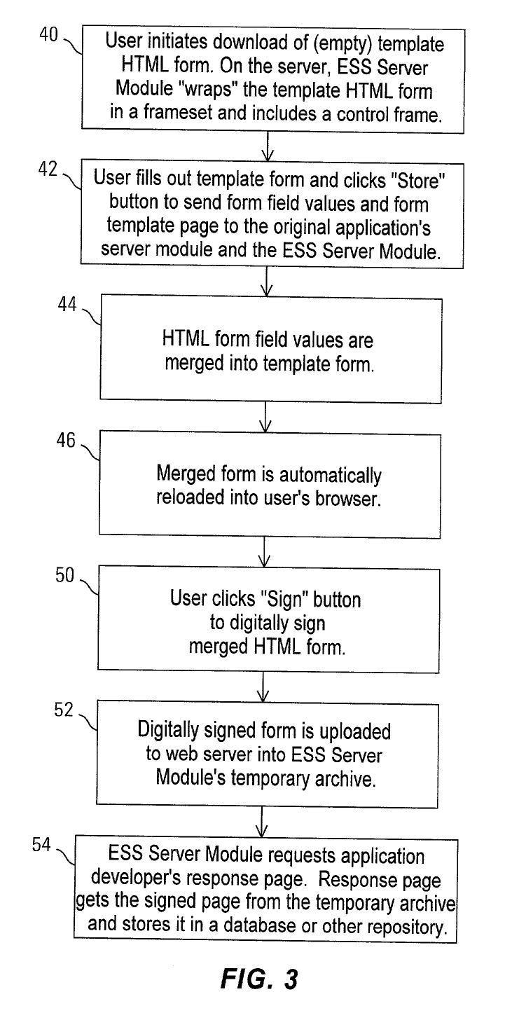

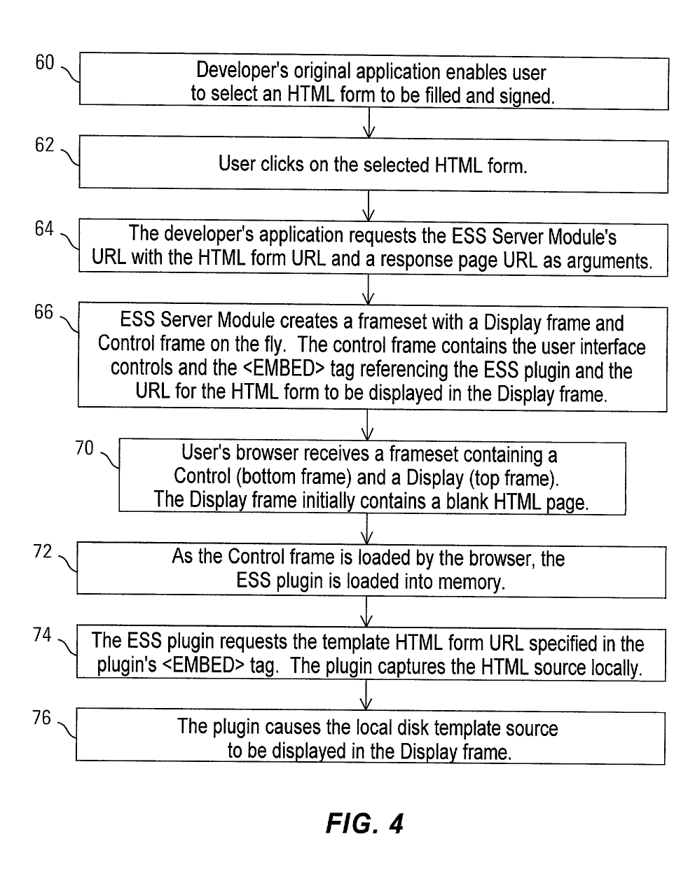

An exemplary overview of the electronic signature process is illustrated in FIG. 3. The user initiates 40 a download of an empty HTML template. On the server, the ESS server module wraps the template HTML form in a frameset and includes a control frame. The user fills out the template and clicks 42 the Store button 24 to send data in the form fields (e.g., 16 and 20) and the form template page to the original application's server module and the ESS server module. The CGI script in the web server merges 44 the HTML form field values into the template form, and the merged form is automatically reloaded 46 into the user's browser. The user then clicks 50 on the Sign button 26 to digitally sign the merged HTML form, and the digitally signed form is uploaded 52 to the web server into the ESS server module's temporary archive. The ESS server module requests 54 the application developer's response page. The response page gets the signed page from the temporary archive and stores it in a database or other repository. Then a response page is rendered in the browser for the end user's confirmation or next step after the signing of the HTML form. The process of loading an empty HTML template is illustrated in FIG. 4. The developer's original application enables 60 the user to select an HTML form to be filled and signed. The user clicks 62 a Uniform Resource Locator (URL) link in a web page or other source to initiate a download of the selected HTML form. The developer's application requests the ESS server module's URL with the HTML form URL and a response page URL as arguments, invoking the ESS server side module wrap a frameset with a control frame around the HTML template. The ESS server module thus creates 66 a frameset with a display frame and control frame on the fly. The control frame contains the user interface controls and the <EMBED> tag referencing the ESS plugin and the URL for the HTML form to be displayed in the display frame 12. The user's browser receives 70 a frameset containing a control frame 10 and a display frame 12. The display frame initially contains a blank HTML page, which will be replaced with a second HTML page as the plugin loads. (The second page is the HTML form that is to be signed by the user.) The URL defining the second HTML page is specified in the plugin's “templateURL” <EMBED> tag attribute as described below.

The control frame page 22 contains the electronic signature system plugin <EMBED> tag. A sample exemplary plugin <EMBED> tag appears as follows:

<EMBED type=application/x-ess-plugin src=“http://www.mysite.net/˜ess_app/params_s_{—}20000911_{—}083010_{—}001.ess”

name=“ess1”

width=0 height=0

sessionState=“start”

templateURL=“http://www.mysite.net/cgi-bin/my_html_form_script.pl?user=doej&my_form_id=568&process_name=GREEN%20QUALIFICATION&process_id=Green123”

templateURLPost=“http://www.mysite.net/cgi bin/ess_templateFileUpload.pl/20011126_{—}180725_{—}001” autoSign=TRUE

autoSignSubmitURL=“/cgi-bin/ess.pl/process?ess_session_id=20011126_{—}180725_{—}001&action=Sign”>

The <EMBED> reference causes the browser to load 72 the ESS plugin into memory. After the plugin loads, it will receive the attribute strings that were present in the <EMBED> tag. The plugin stores the “templateURL”, “templateURLPost”, etc. values in memory for later use. The plugin then examines the value of the “sessionState” attribute. If sessionState has a value of “start”, the plugin will assume that this is the start of a new signing transaction and not the continuation of an existing transaction.

Next, the browser downloads the parameter file named in the “src” attribute of the <EMBED> tag (i.e. the params_s_???.ess file.) The electronic signature system (ess) parameters stored in the params_s_???.ess file are used to store plugin configuration parameters and other information. An electronic signature system enabled application can dynamically alter the default behavior of the plugin using the ess file. For the signing phase, the parameter file is named param_S_YYYYMMDD_HHMMSS_SSS.ess, which is the concatenation of “param_s_” and the session ID. YYYYMMDD represents the current Year, Month, and Day, and HHMMSS represents the current Hour, Month, and Second. SSS represents the 3 digit unique sequence number, although it may alternatively represent milliseconds. For each end user signing transaction, CGI code creates a params_s_???.ess file “instance” and creates a reference to it in the <EMBED> tag. The server copy of the params_s_???.ess file is deleted at the end of the signing process (or, by a clean-up routine, for signing processes that were aborted.) Next, the browser delivers the contents of the .ess file to the plugin for processing. The plugin parses the “name-value” parameters contained within the .ess stream and stores them in memory.

After the plugin finishes receiving the ESS parameters, it performs a Netscape plugin API GetURLNotify() request, to request 74 the HTML template identified by the “templateURL” attribute in the plugin's <EMBED> tag. The plugin captures the HTML source locally. The plugin causes the local copy of the HTML template to be displayed 76 in the display frame 12.

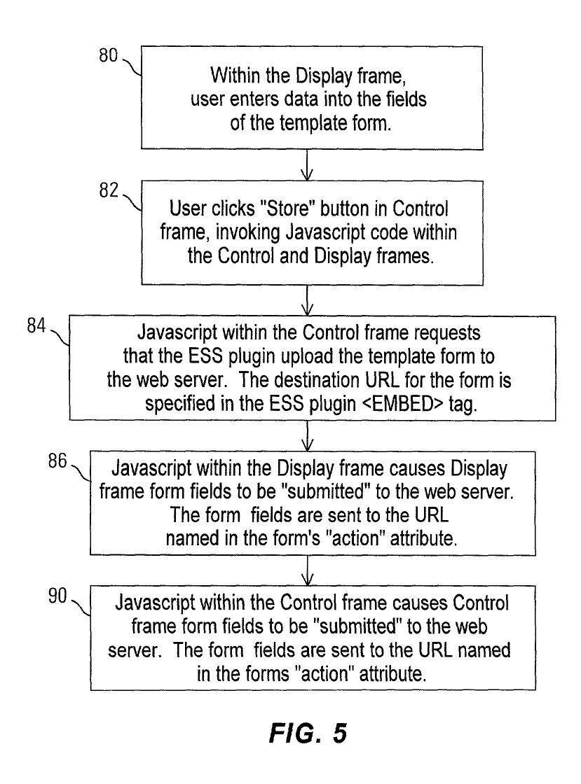

The user then fills out and submits the HTML form (e.g., 14) that is displayed in the display frame 12, as illustrated in FIG. 5. The user first enters data 80 into the data entry fields (e.g., 16 and 20) in the HTML form (e.g., 14). The user then clicks 82 the Store button 24 in the control frame 10, invoking a Javascript method (i.e. freeze_display_file( )).

The Javascript method performs the following three actions:

First, the Javascript method within the control frame page 22 requests that the plugin post or upload 84 the local disk copy of the HTML form to the web server at the location indicated by the <EMBED> tag's “templateURLPost” attribute. (The plugin code performs an HTTP POST operation.) The web server script named in the “templateURLPost” attribute stores the posted file on the web server.

A session_ID string is supplied at the end of the templateURLPost address as “path info”. The ESS web server module then creates a file called: YYYYMMDD_HHMMSS_SSS_template_form.htm in a predetermined web server subdirectory.

Next, the Javascript method calls 86 a “display_submit( )”s method in the display frame page 14 (as seen at the end of this description in the sample HTML source for the display frame page 14). The sessionID is passed as an argument to the display_submit( ) method. NOTE: Each display frame page contains a hidden field called “ess_session_id”. The display_submit( ) method will load the identifier passed in sessionID into the ess_session_id field. The display_submit( ) method then calls the page's HTML submit( ) method. At this point, the control frame and the display frame pages 22 and 14 will have different domains. The Javascript “same domain” security check is worked around by having the control frame's Store button 24 call an HTML form submit( ) wrapper routine in the display frame page 14. Next, the web developer's <FORM> submit URL calls CGI functions in the electronic signature system field merging API to merge the field values into the templateURL page producing a new document called the YYYYMMDD_HHMMSS_SSS_merged_form.htm.

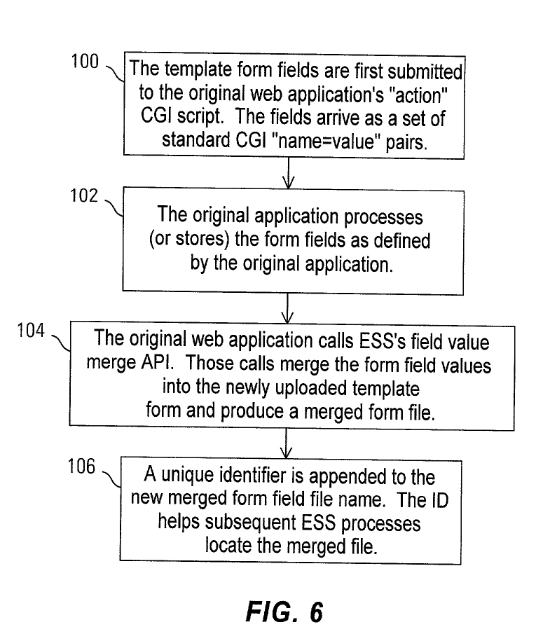

An exemplary process of merging HTML form fields into the HTML template is illustrated in FIG. 6. The template form fields are first submitted to the original web application's “action” CGI script. The fields arrive as a set of standard CGI “name=value” pairs. The original application processes 102 (or stores) the form fields as defined by the original application. The original web application calls the ESS API for merging form field values 104 (as listed in the exemplary original application CGI script listed at the end of this description) which merges the form field values into the newly uploaded template form to produce a merged form file. A unique identifier is appended 106 to the new merged form field file name. The identifier helps subsequent electronic signature processes to locate the merged file.

Note that although the exemplary electronic signature system described herein applies the electronic signature to an HTML form with data merged in, the electronic signature could alternatively be applied to the data only if desired. However, merging the data with the form before signing provides a more portable document in which the data is meaningful without needing the original HTML template.

Finally, after the display frame's template form is POSTed and the display frame HTML form is submitted, the Javascript method causes the control frame page 22 to be submitted 90 to the web server. The control frame's HTML form 22 passes parameters to the ESS server module script indicating that the user pressed the Store button 24 (rather than the Sign button 26). The control form 22 also passes the session id and other attributes to the server script.

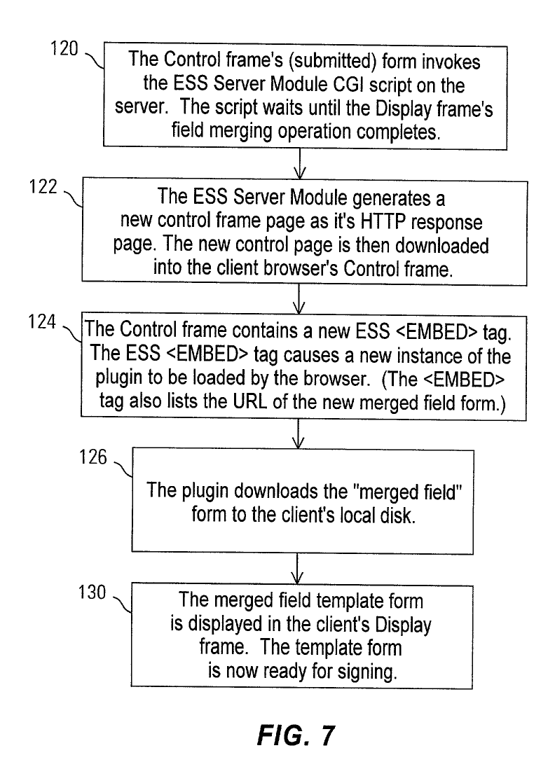

After the HTML form and data have been merged in the web server, the resulting merged HTML form is reloaded from the web server into the client's browser, as illustrated in FIG. 7. The submission of the control frame page 22 invokes 120 the ESS server module on the server, which waits until the “form field merging” web server script has completed execution before the ESS server module downloads the newly merged HTML form (e.g., 14) to the client's browser. The web server script that processes the control form submission waits until it can find a “YYYYMMDD_HHMMSS_SSS_merged_form.htm” file in the ESS\session directory. In order to properly sequence their actions, the “form field merging” and control scripts utilize a software semaphore.

The ESS server module next generates 122 an updated control form as its response page. The response page contains a new electronic signature system <EMBED> tag. When the response page is loaded into the client browser and the new <EMBED> tag is encountered, the current plugin instance is deleted and a new instance is created. After the new ESS plugin loads, it will process the attributes that are defined in the new <EMBED> tag. Next, the plugin will fetch the page identified by the “templateURL” attribute and display it in the display frame window. The page identified by templateURL contains the merged HTML form including the field values entered by the user before the user clicked the Store button 24 in the control page 22. (The Netscape plugin API GetURLNotify( ) call will be used to retrieve the merged templateURL URL.) The plugin downloads 126 the merged HTML form, saving it to the client's local disk. The plugin then performs a second GetURLNotify( ) request, referencing the URL of the merged HTML form that was just saved as a local file, to display 130 the merged HTML form in the display frame 12. The merged HTML form in the display frame 12 is now ready to be electronically signed. Note that the browser's “GoTo:” field will not show that the page in the display frame is a local file. However, the user may right click on the display page and select “View Page Info” to reveal that it is a local file.

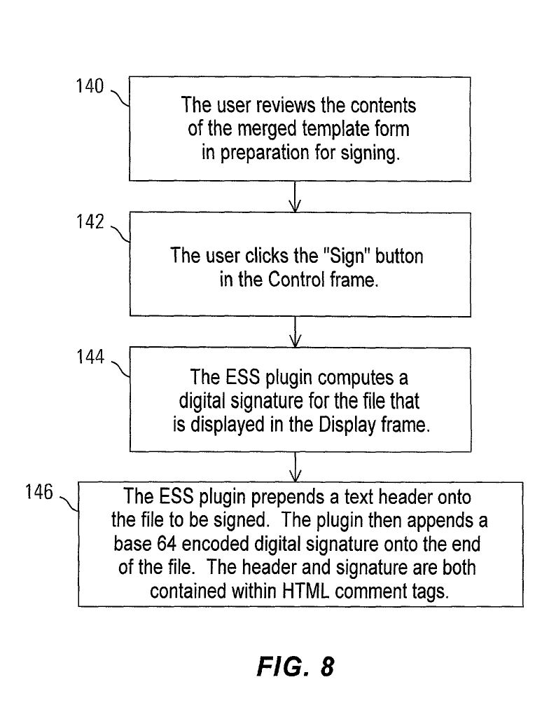

An exemplary process of electronically signing the merged form is illustrated in FIG. 8. After the user has reviewed 140 the contents of the merged form, the user clicks 142 the Sign button 26 in the control frame 10. The Sign button 26 causes all of the steps that are normally executed under the store operation described above to be executed and then sends information to the web server scripts to transition the sessionState attribute to the “pre_sign” state. (Thus it is not necessary to click the Store button 24 before the Sign button 26.)

As in the case of a normal Store operation, a new control page is downloaded back into the browser. With a sessionState of pre_sign, the plugin will perform a Netscape plugin API GetURLNotify( ) call and request the page indicated by the URL named in the “signURL” attribute. The signURL attribute references the merged HTML form, so the merged form is downloaded into the display frame 12. As described above, the incoming merged HTML form is saved to disk and the plugin stores the file's disk location. The plugin performs a second GetURLNotify( ) request referencing the merged form that was just saved as a local file, and the merged form is displayed in the display frame 12.

Because the autoSign attribute is TRUE, the plugin automatically proceeds to invoke a SignPage( ) method in the plugin. The SignPage( ) method computes 144 a hash and digital signature for the local copy of the merged HTML file. The electronic signature is attached 146 to the local copy of the merged HTML form indicated by the “signURL” attribute. The electronic signature is attached after the </HTML> tag within an HTML comment tag. A text header or information block is attached to the merged HTML form in an HTML comment, containing information about the signer of the document, the current date and time, etc. Most of the signer information is extracted from the signer's digital certificate.

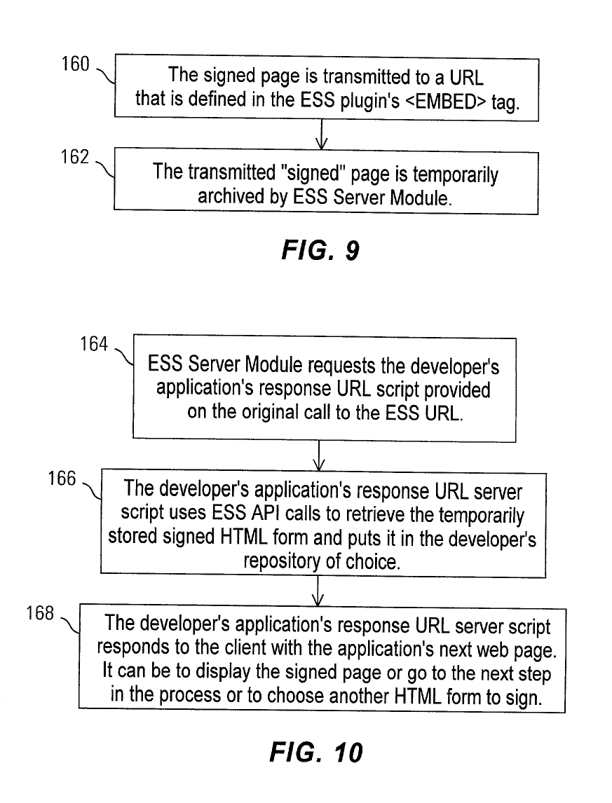

The electronically signed HTML form is then uploaded to the web server, as illustrated in FIG. 9. The plugin POSTs 160 the electronically signed form to the URL named in the “signedURLPost” attribute defined in the plugin's <EMBED> tag. Next, the plugin issues an HTTP GET request to the web server using the URL defined in the <EMBED> tag's “autoSubmitURL” attribute. (This mimics the user pressing a button in the control form 22 and invoking a form action.) The GET request causes a corresponding web server script in the ESS server module to execute and process the POSTed (uploaded) electronically signed form. The ESS server module creates 162 a temporary archive of the signed HTML page along with a static frameset and control frame.

The original application archives the signed HTML page and responds as illustrated in FIG. 10. The ESS server module requests 164 (invokes) the application's response URL script provided on the original call to the ESS URL as the “Your Response” URL, passing it the ess_session_id field value. The web application developer code uses the passed ess_session_id field to locate the signed HTML page, static frameset, and corresponding control frame. At this point, the “Your Response” URL script provided in the developer's original application uses ESS API calls to retrieve 166 the temporarily stored signed HTML form and store it (and associated parts) in the developer's repository of choice, such as a database or other application specific repository. The application's response URL server script responds 168 to the client with the applications next web page. This page can direct the user to the next step in the signing process, such as displaying the signed page, going on to the next step in the process, or presenting a choice of further HTML forms to sign. The electronically signed HTML form can optionally be downloaded 164 back to the client machine along with support frames. The electronically signed HTML form can thus be locally stored and verified without again fetching the form from the server.

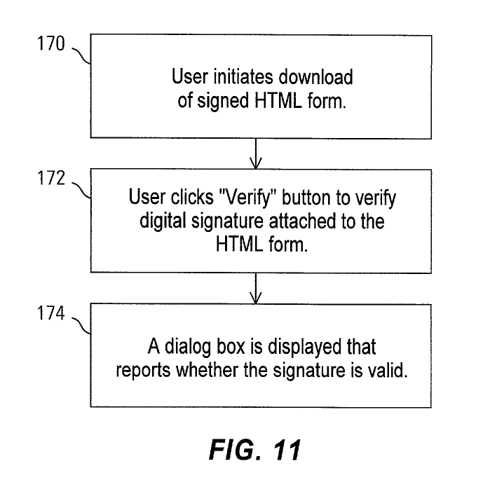

Referring now to FIG. 11, to verify an electronic signature on an HTML form, the user initiates the download 170 of the signed HTML form. The user clicks 172 on the Verify button 32 in the control page 30 to verify the electronic signature. A dialog box is then displayed 174 indicating whether the signature is valid.

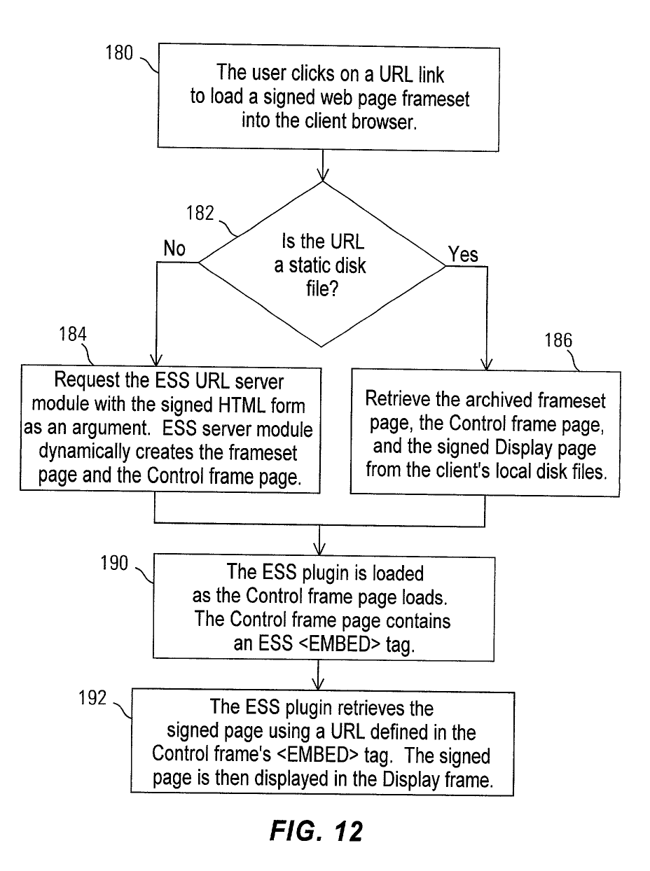

The details of an exemplary process of downloading 170 the signed HTML form into a client browser is illustrated in FIG. 12. The user clicks 180 on a URL link to load the frameset for the signed HTML form into the client browser. This frameset includes three files, the signed HTML form, a static version of the control page (e.g., 30) containing a Verify button 32, and a static page with two frames tying the other two files together.

If 182 the URL link does not point to a static disk file, a request is made 184 to the ESS URL server module with the signed HTML form as an argument. The ESS server module dynamically creates the frameset page and the control frame page 30. To retrieve these pages, the plugin calls GetURLNotify( ) to retrieve the URL named by the verifyURL attribute. As the pages are retrieved, they are stored in a local disk file and displayed.

If 182 the URL link does point to a static disk file, the archived frameset, the control page 30, and the blank display page is retrieved 186 from the client's local disk files.

The ESS plugin is loaded 190 as the control frame page 30 is loaded, because of an embedded electronic signature <EMBED> tag, as described above. The ESS plugin retrieves 192 the signed HTML form using a URL defined in the control frame page's 30 <EMBED> tag, and the signed HTML form is displayed in the display frame 12.

The control frame page 30 contains an <EMBED> tag that references the electronic signature plugin MIME type. The <EMBED> tag does not contain a “src” attribute reference to a .ess file, because the parameters that were in effect when the form was last signed were recorded just above the digital signature in the header information block and thus are accessible to the plugin. The <EMBED> tag also contains a sessionState attribute which describes the current session state for the plugin. The sessionState attribute is set to “verify” to signal the plugin that it is not performing a signing operation, and thus no .ess file will be needed. The <EMBED> tag also contains a verifyURL attribute which contains the URL of the signed HTML form that is to be verified.

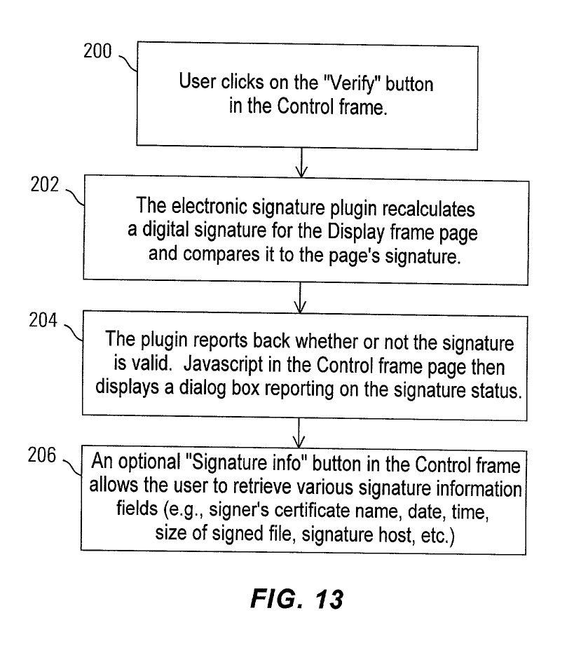

Details of the exemplary verification process are illustrated in FIG. 13. The user clicks 200 on the Verify button 32 in the control frame page 30 to verify the electronic signature. The Verify button 32 is tied to a Control_VerifySignature( ) Javascript method that then calls a VerifySignature( ) routine in the plugin. The plugin then performs a signature verification on the local disk file (i.e. the file currently displayed in the display frame), by recalculating 202 a digital signature for the display frame page and comparing it to the stored electronic signature. The plugin returns 204 a TRUE or FALSE value from the VerifySignature( ) routine, and Javascript code embedded in the control frame page 30 displays a dialog window reporting whether (or not) the signature was valid.

A “Signature Information” button (not shown) can optionally be provided in the control frame page 30, allowing 206 the user to retrieve signature information fields such as the signer's certificate name, the date, time and size of the signed file, the signature host, etc.

The electronic signature system described above uses an X.509 Public Key Infrastructure (PKI) digital certificate which contains the user's public/private key information, although it may alternatively use other types of suitable signature technologies. The digital certificate may be the same as that used by the underlying web browser and may be obtained from the digital certificate store used by the Internet Explorer browser. Tools are provided for managing the electronic signature generator (i.e. plugin). For example, the plugin provides a Graphical User Interface (GUI) with dialogs for viewing, importing, exporting, and selecting digital certificates. The plugin also supports storage and retrieval of certificates from floppy disks. Using this feature, a user can store their private key information on a removable disk and prevent a hacker from ever obtaining their private key. Using the GUI, the plugin can be configured to use the floppy based certificate store rather than the store that is used by the browser. While illustrative and presently preferred embodiments of the invention have been described in detail herein, it is to be understood that the inventive concepts may be otherwise variously embodied and employed, and that the appended claims are intended to be construed to include such variations, except as limited by the prior art.

Sample HTML source code for the control frame page 22 of FIG. 1 is as follows:

<!doctype html public “-//w3c//dtd html 4.0
transitional//en”>
<BASE HREF=“http://www.mysite.net/cgi-bin/ess.pl/”>
<html>
<head>

<meta http-equiv=“Content-Type” content=“text/html;

charset=iso-8859-1”>

<title>Form to electronically sign</title>

<script language=“JavaScript1.1” >
// Globals

var signingCertSubject;
var signingCertIssuer;
var signingCertSerialNum;
var wait_cumulative;
function print_signingCertSubject ( ) { document.write(

‘<b>Signer: </b>’ + GetDefaultSigningCertInfo(
“SigningCertSubject”) + ‘<BR>’); }

function GetDefaultSigningCertInfo(fieldName) {

var lastErrorNum = 0;
var fieldValue;
var strOut;
document.ess1.ClearLastError( );
fieldValue =

document.ess1.GetDefaultSigningCertInfo(fieldName);

lastErrorNum = document.ess1.GetLastErrorNum( );
if (lastErrorNum == 0) { strOut = fieldValue; }
else { strOut =document.ess1.GetLastErrorMsg( ); }
return strOut;

}
function GetDefaultSigningCertInfoW( ) {

// Get ‘Default Signing Cert’ Info fields
signingCertSubject =

GetDefaultSigningCertInfo(“SigningCertSubject”);

signingCertIssuer =

GetDefaultSigningCertInfo(“SigningCertIssuer”);

signingCertSerialNum =

GetDefaultSigningCertInfo(“SigningCertSerialNum”); }
function ess_load_check( ) {

var result;
result = document.ess1.DSSInitialized( );
if (result==false) {

alert (“DSSInitialized( ) result=” + result);
alert (“Error: ” +document.ess1.GetLastErrorNum( ));
alert (“Error: ” +document.ess1.GetLastErrorMsg( ));

}

else { GetDefaultSigningCertInfoW( ); }}

function freeze_display_file(store_type) {

var result = true;
result = document.ess1.PostTemplateURL( );
if (result==false) {

alert(“Template posting error. Try Freezing

again.”);

alert (“Error: ” +document.ess1.GetLastErrorNum( ));
alert (“Error: ” document.ess1.GetLastErrorMsg( ));}

else {

document.controlFrm.action.value = store_type;
wait_cumulative = 0;
wait_and_store( ); }}

function wait_and_store( ) {

var result;
result = document.ess1.GetLastPostStatus( )
if (result == “Status_Awaiting_Response”) {

if (wait_cumulative < 10) {

setTimeout(“wait_and_store( )”, 1000); //1 second
wait_cumulative = wait_cumulative + 1;

} else {

alert (“Waited enough! PostStatus is ”+result); }

```
}else if (result == “Status_Post_Completed”) {
  parent.display.displaySubmit(“20011126_180725_001”);
    document.controlFrm.submit( );
} else {
```

alert (“Template Posting Error: ” + result); }}

function sign_display_file( ) {

var result = true;
result = document.ess1.SignPage(“Sign msg”);
if (result==false) {

alert (“Error: ”+document.ess1.GetLastErrorNum( ) );
alert (“Error: ”+document.ess1.GetLastErrorMsg( ) );

} else {

wait_cumulative = 0;
wait_and_archive( ); }}

function wait_and_archive( ) {

var result;
result = document.ess1.GetLastPostStatus( )
if (result == “Status_Awaiting_Response”) {

if (wait_cumulative < 10) {

setTimeout(“wait_and_archive( )”, 1000); //1 sec
wait_cumulative = wait_cumulative + 1;

} else {
alert (“Waited enough! PostStatus is ” +result); }

}else if (result == “Status_Post_Completed”) {

document.controlFrm.action.value = “Sign”;
document.controlFrm.submit( );

} else { alert (“Sign Posting Error: ” + result); }}

</script>

</head>

<body onLoad=“ess_load_check( )”>&nbsp;

<center><table BORDER=0 CELLSPACING=0 CELLPADDING=7>

<tr VALIGN=TOP>

<td><embed type=application/x-ess-plugin name=“ess1”

width=0 height=0

sessionState=“start”

src=“http://www.mysite.net/˜ess_app/params.ess”

templateURL=“http://www.mysite.net/cgi-bin/

my_html_form_script.pl?user=doej

&my_form_id=568&process_name=GREEN%20QUALIFICATION&proces

s_id=Green123%”

templateURLPost=“http://www.mysite.net/cgi-bin/

ess_templateFileUpload.pl/20011126_{—}180725_{—}001”

autoSign=TRUE

autoSignSubmitURL=“/cgi-bin/

ess.pl/process?ess_session_id=20011126_{—}180725_{—}001&action=

Sign”><b>Signer:&nbsp;

</b>John Doe</td>

<td>

<center><form METHOD=“GET” ACTION=“/cgi-bin/

ess.pl/process”

ENCTYPE=“application/x-www-form-urlencoded”

NAME=“controlFrm”><input TYPE=“hidden”

NAME=“ess_session_id” VALUE=“20011126_{—}180725_{—}001”><input

TYPE=“hidden” NAME=“action” VALUE=“start”><input

TYPE=“button” NAME=“action_button” VALUE=“Store”

ONCLICK=“freeze_display_file(&quot;Store&quot;)”><input

TYPE=“button” NAME=“action_button” VALUE=“Sign”

ONCLICK=“freeze_display_file(&quot;Final_Store&quot;)”></

form></center>

</td>

<td>Scroll down for instructions.</td>

</table></center>

<LEFT>

<table BORDER=0 CELLSPACING=0 CELLPADDING=2>

<tr VALIGN=TOP>

<td><b>Instructions</b>

<br>You may edit the form above. Any changes can be registered by clicking the Store button.

<br>Clicking the Sign button will also register changes before your signature is applied. You may “Sign”.</td>

</tr>

</table>

</LEFT>

</body>

</html>

Sample HTML source code for the control frame page 30 of FIG. 2 is as follows:

<HTML><HEAD>
<TITLE>Electronic Signature System</TITLE>
<script language=“JavaScript1.1” >
// Globals

var sign_subject;
var sign_date;
var sign_time;
var sign_time_zone;

function print_signerCertSubject( ) {

document.write(‘<b>Signed By: </b>’ +

get_ess_signature_info(“SIGNING_CERT_SUBJECT”,“FromFile”)
+ ‘<BR>’);}
function get_ess_signature_info(fieldName, source) {

var lastErrorNum = 0;
var fieldValue;
var strOut;
document.ess1.ClearLastError( );
fieldValue = document.ess1.VerifyGetESSSignatureInfo

(fieldName, source);

lastErrorNum = document.ess1.GetLastErrorNum( );
if (lastErrorNum == 0) { strOut = fieldValue; }
else { strOut = document.ess1.GetLastErrorMsg( ); }
return strOut;}

function get_ess_signature_info_w( ) { sign_subject =
get_ess_signature_info(“SIGNING_CERT_SUBJECT”,“FromFile”
);

sign_date = get_ess_signature_info(“LOCAL_DATE”,

“FromCache” );

sign_time = get_ess_signature_info(“LOCAL_TIME”,

“FromCache” );

sign_time_zone =

get_ess_signature_info(“LOCAL_TIME_ZONE”, “FromCache”);}
function ess_load_check( ) {

var result;
result = document.ess1.ESSInitialized( );
if (result==false) {

alert (“ESSInitialized( ) result=” + result);
alert (“Error: ”+document.ess1.GetLastErrorNum( ));
alert (“Error: ”+document.ess1.GetLastErrorMsg( )); }}

function verify_signature( ) {

var result = true;
result = document.ess1.VerifyPageSignature (“Verify
msg”);
if (result==false) {

alert (“verify_signature( ) result=” + result);
alert (“Error#: ”+document.ess1.GetLastErrorNum( ));
alert (“Msg: ” + document.ess1.GetLastErrorMsg( ) );
alert (“Code Location: ” +

document.ess1.GetLastErrorLocation( ) );

document.ess1.ClearLastError( );

}else {

get_ess_signature_info_w( );
alert (“Signature Verifies” +

“\n\nSigned By: ” + sign_subject +
“\nDate: ” + sign_date +
“\nTime: ” + sign_time +
“\nTime Zone: ” + sign_time_zone);

document.ess1.ClearLastError( ); }}

</script>

</HEAD><BODY onLoad=“ess_load_check( )”>

<CENTER><TABLE cellspacing=0 border=0 cellpadding=7>

<TR VALIGN=“TOP”><TD>

<EMBED type=application/x-ess-plugin name=“ess1”

width=3 height=2

sessionState=“verify”

verifyURL=“20011126_{—}181744_{—}001_display.htm”>

</TD><TD>

<FORM METHOD=“POST”

ENCTYPE=“application/x-www-form-urlencoded”

NAME=“controlFrm”>

<INPUT TYPE=“button” NAME=“verify” VALUE=“Verify

Signature” ONCLICK=“verify_signature( )”>

</FORM></TD></TR></TABLE></CENTER>

</BODY></HTML>

Sample Perl source code for an exemplary application script calling the ESS form field merging API:

use strict;

use ESS_FileHandling qw(:DEFAULT $templateHTMLFile

$mergedHTMLFile);

use FormValueMerge;

my(%theFieldVals); # Variable for mergeFieldVals( )

my($signSessionId); # Variable to id ess signing session

my($status)=1; # Variable for result status

my($self)=“signFormBaseCgi”; #id caller-ESS_FileHandling

#---Populate the field value hash.

$status=&convert_cgi_params_to_hash(\%theFieldVals); if (!$status){

&returnResponse (“Error in cgi params.\n”);

warn “Can't convert cgi params: $!”;}

#---Getting ess session id if using the ESS plugin.

$signSessionId=&getSignSessionIdValue(\%theFieldVals);

if (!$status){

&returnResponse (“Error getting a session id.\n”);

warn “Cant get session id: $!”;}

#---Create ESS related filenames if using ESS plugin.

$status=&ecreateESSfilenames($signSessionId);

if (!$status){

&returnResponse (“Error creating ESS filenames.\n”);

warn “Cant create ESS filenames.”;}

#---Open, lock source and dest files before merging.

$status=&open_ess_synchronizer($self);

if (!$status){

&returnResponse (“Error getting ESS Semaphore.\n”);

warn “Cant get the ESS Semaphore.”;}

$status=&openSource($templateHTMLFile, *SRCHTMLh, $self);

if ($status == −1) {

&returnResponse(“HTML source file doesn't exist!”);
warn “File does not exist: $!”;
}elsif ($status == −2) {
&returnResponse (“Error opening $templateHTMLFile!”);
warn “Cant open source: $!”;
}elsif ($status < 1) {
&returnResponse (“Error with $templateHTMLFile!”);
warn ”Cant open source: $!”; }

$status=&openDestination($mergedHTMLFile, *DESTHTML1h, $self);

unless ($status==1){

&returnResponse(“Error opening $mergedHTMLFile!”);

warn “Cant open destination: $!”;}

#---Merge field values with source HTML

#Output is one or two destination HTML streams.

#-If STDOUT is used as one destination:

#Pass STDOUT as second stream handle,

#and an optional file handle as third.

#Example code:

#my($dest2Handle)=*DESTHTML1h;

#print “Content-type: text/html”, “\n”;

#If using STDOUT then header needed.

#$status=&mergeFieldVals(*SRCHTMLh, *STDOUT, $dest2Handle, \%theFieldVals );

#-If no second destination is used:

$status=&mergeFieldVals(*SRCHTMLh, *DESTHTMLlh, 0, \%theFieldVals);

#Output to STDOUT either No Response or the merged HTML,

#if ESS plugin and a Sign Control frame are used.

print “Content-type: text/html”, “\n”;

print “Status: 204 No Response”, “\n\n”;

#---Close, unlock ESS files. Call if openSource called.

$status=&closeHTML (*DESTHTML1h, $self);

$status=&closeHTML (*SRCHTMLh, $self);

$status=&close_ess_synchronizer( );

exit(0);

sub returnResponse {

my($msg)= @_;
print “Content-type: text/html”, “\n”;
print “Target: debug”, “\n\n”;
print “<HTML><HEAD>\n”;
print “<TITLE>”, “Merge Response”, “</TITLE>”, “\n”;
print “</HEAD>\n”;
print “<BODY>\n”;
print “<H1>$msg</H1>\n”;
print “</BODY></HTML>”;

}

What is claimed is:

1. A method of electronically signing a hypertext markup language form, comprising:
loading said hypertext markup language form into a browser application; and
generating an electronic signature for information in said hypertext markup language form from within said browser application.

2. The method of claim 1, wherein said electronic signature comprises a public key infrastructure digital certificate.

3. The method of claim 1, wherein said hypertext markup language form comprises at least one data field.

4. The method of claim 3, wherein said electronic signature is generated for data in said at least one data field.

5. The method of claim 3, further comprising merging data in said at least one data field with said hypertext markup language form to create a merged form.

6. The method of claim 3, wherein said electronic signature is generated for said merged form.

7. The method of claim 1, further comprising attaching said electronic signature to said hypertext markup language form.

8. The method of claim 7, wherein said attaching comprises appending a digital signature onto the end of a file containing said hypertext markup language form in a comment tag.

9. The method of claim 8, wherein said attaching further comprises prepending a text header onto said file in another comment tag.

10. The method of claim 7, further comprising transmitting said hypertext markup language form with said attached electronic signature to a web server.

11. The method of claim 10, wherein said transmitting to said web server comprises transmitting to a web server for processing by a common gateway interface script.

12. A method of verifying an electronic signature of a hypertext markup language form, comprising:
loading said hypertext markup language form into a browser application;
generating an electronic signature for information in said hypertext markup language form from within said browser application; and
comparing said electronic signature with a stored electronic signature in said hypertext markup language form.

13. The method of claim 12, further comprising indicating whether said electronic signature matches said stored electronic signature.

14. The method of claim 12, further comprising displaying information about said stored electronic signature.

15. An apparatus for electronically signing a hypertext markup language form, comprising:
a. one or more computer readable storage media; and
b. computer executable program code stored in the one or more computer readable storage media, the computer executable program code comprising:
i. code for loading and displaying said hypertext markup language form;
ii. code for generating an electronic signature for information in said hypertext markup language form from within a browser; and
iii. code for verifying an electronic signature attached to said hypertext markup language form.

16. The apparatus of claim 15, wherein said code for generating said electronic signature comprises plugin code for said browser.

17. The apparatus of claim 15, wherein said code for generating said electronic signature utilizes a public key infrastructure digital certificate.

18. The apparatus of claim 15, further comprising code for transmitting said hypertext markup language form and data in at least one field in said hypertext markup language form to a server.

19. The apparatus of claim 15, further comprising code for merging data in at least one field in said hypertext markup language form with said hypertext markup language form.

20. The apparatus of claim 19, wherein said code for merging data does not interfere with posting of said at least one field to a server application.

21. The apparatus of claim 15, wherein said code for verifying said electronic signature comprises:
1. code for generating a new electronic signature for said information in said hypertext markup language form; and
2. code for comparing said new electronic signature with said electronic signature attached to said hypertext markup language form.

22. The apparatus of claim 15, wherein said code for loading and displaying said hypertext markup language form displays said hypertext markup language form in a first frame and displays at least one user interface button in a second frame, said at least one user interface button for initiating said code for generating said electronic signature and said code for verifying said electronic signature.
